(19) United States
(12) Patent Application Publication
(10) Pub. No.: US 2007/0257018 A1
(43) Pub. Date: Nov. 8, 2007

(54) Programmable Thermally Controlled Electric Heating Mattress

(76) Inventor: Henry D. Huang, Edison, NJ (US)

Correspondence Address: HENRY D. HUANG, 104 MOUNT PLEASANT AVE., EDISON, NJ, 08820, US

(21) Appl. No.: 11/381,529

(22) Filed: May 3, 2006

(51) Int. Cl. H05B 1/00

(52) U.S. Cl. 219/217

(57) ABSTRACT

The programmable thermally controlled electric heating mattress comprises a conventional mattress, a microprocessor-based electronic controller, and a heating element. The heating element is a removable pad, which fastens onto the top surface or under the upper layer material of the mattress. The location and size of the heating element is such that it covers the lower body (feet and legs) of the user when the user lies down on the mattress. By providing heat to the feet, heat naturally transfers to other parts of the body through blood flow. The design minimizes the health risk, saves energy and cost, and creates a comfortable gradient heat zone to the user. A programmable microprocessor-based electronic controller provides the features of automatically controlling the heating pad temperature and on/off time, as well as monitoring the system safety. In one embodiment, the electronic controller is mounted to the side of the mattress body. In the second embodiment, the controller comprises two separate but similar function units: a wireless remote control and a base unit. The base unit is mounted to the mattress body. The wireless remote control is a handheld or tabletop unit. User can use either the wireless remote control or the base unit to program and control the system.

### BACKGROUND AND SUMMARY OF THE INVENTION

Several patents, U.S. Pat. Nos. 4,423,308, 4,074,107, and 4,162,393 disclosed different heating mattress designs, yet all have a very similar heating element arrangement: the heating pad covers nearly the entire surface of the mattress top. The fact that almost the entire human body in close contact with the heating pad for a continuous period of 7˜8 hours becomes a major safety concern. Heat burn, electric shock, and exposure to strong electromagnetic fields are some of the potential health risks with such designs.

It has been a common knowledge that if your feet are warm, your whole body will be comfortably warm. Different parts of the human body sense heat differently. In general, the upper body is more sensitive to heat comparing to the lower body in terms of the normal comfort level. Feet can tolerate relatively higher heat. Furthermore, by exposing the feet to heat, blood flow transfers the heat to other parts of the body, thus creating a comfortable heat gradient to the entire body. This experience suggests that there is no need to have the heating pad covering nearly the entire top surface of the mattress.

Based on this principle, our invention overcomes the inherent disadvantage of the prior arts by having the heating pad in the position such that it covers the user's feet and legs when the user lies down on the mattress. Heat is naturally distributed to the entire body by blood flow, thus providing a comfort thermal gradient. Such a design significantly saves energy and reduces cost, and most importantly, provides a safe and comfortable sleep environment to users.

One of the primary objectives of the invention is to have a programmable microprocessor-based electronic controller to control the heating pad in an automatic manner. Users can program his or her preferable heating profile. Once programmed, the controller will automatically turn on the heating pad before bedtime to pre-warm the mattress, maintain a comfortable temperature through sleep, and turn off the heating element after sleep. The controller also monitors the heating pad temperature to insure safety.

### BRIEF DESCRIPTION OF THE DRAWINGS

FIG. 1 illustrates the first embodiment of the invention. The heating pad is either fastened to the top surface or placed under the upper layer material of the mattress. The location of the heating pad is at the user's feet position when the user lies down on the mattress. The size of the heating element is large enough to cover different user's lower body. The heating pad has one or more than one separated heating zones. The programmable microprocessor-based electronic controller is mounted to the side of the mattress body.

FIG. 2 is an example of the programmable microprocessor-based electronic controller, which is mounted to the side of the mattress body. The LCD displays the heating pad temperature, day/time, and control functions. Keypads are used for programming and controlling.

FIG. 3 is the exemplary application of the invention. The heating pad is fastened onto the top surface or under the upper layer material of the mattress. It also shows the size and location of the heating pad, which covers the user's legs and feet location in lying position.

FIG. 4 illustrates the mattress thermal gradient. The foot-section of the mattress is warmer and gradually decreases towards the head-section of the mattress, which provides a comfort thermal gradient to the user's body.

FIG. 5 is an example of the heating pad program profile on the “AUTO” mode. The controller automatically turns on the heating pad at 9:00 pm, about half-hour before bedtime, and prewarms the heating pad to 98° F. From 12:10 am to 2:00 am the heating pad temperature gradually decreases to 90° F. and maintains the same temperature until 5:30 am. At 5:30 am the controller automatically turns off the heating pad. The heating pad temperature slowly returns to room temperature thereafter.

FIG. 6 is the perspective view of the second embodiment of the invention. The controller is consisted of two electronic units: a wireless remote control and a base unit. Both units have similar features. Users can use either unit to program and control the heating pad, as well as displaying information. Similar to the first embodiment the base unit is mounted to the side of the mattress body.

FIG. 7 is an exemplary design of the wireless remote control.

### DETAILED DESCRIPTION OF THE INVENTION

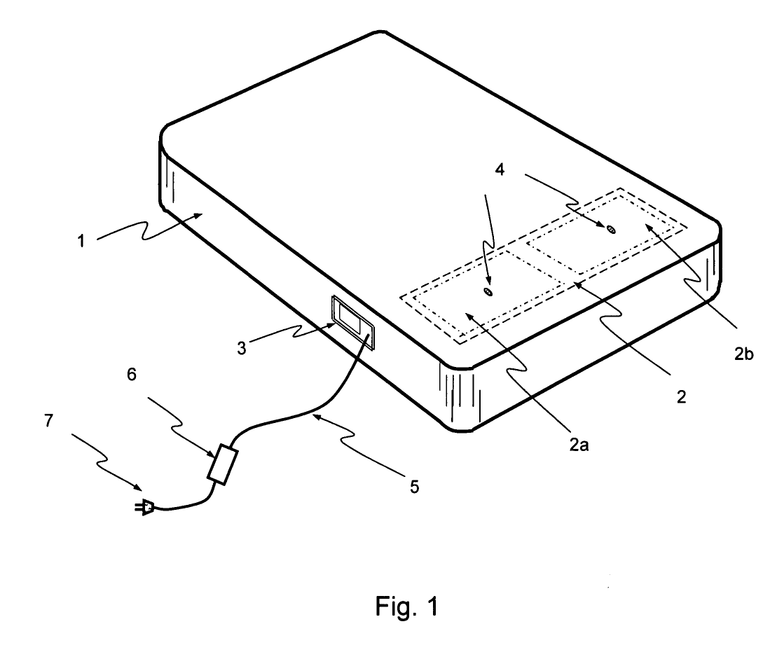

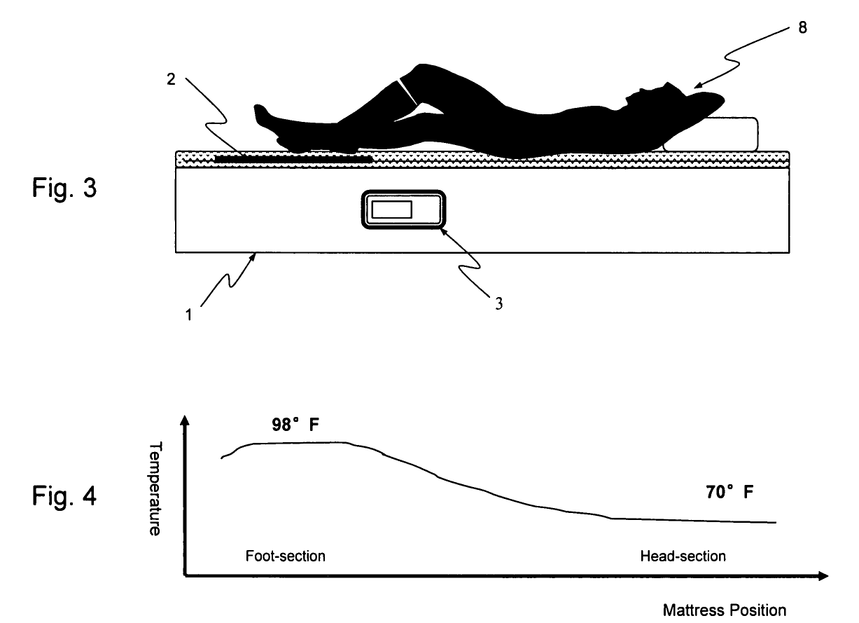

In here, we describe in more details of the invention. FIG. 1 illustrates the exemplary embodiments of the electric heating mattress. A removable heating pad 2 is fastened onto the top surface or under the upper layer material of the mattress body 1. As illustrated in FIG. 3, the heating pad 2 is located at the user's lower body (feet and legs) when user 8 lies on the mattress. The heating pad 2 warms the user's feet. Blood circulation and air naturally transfer heat to the upper body and warms the whole body comfortably. Because the heating pad 2 is the only heat source, the foot-section of the mattress is generally warmer. The mattress temperature gradually decreases from foot-section toward head-section of the mattress 1, forming a comfort thermal gradient that matches with what human body senses in temperature. FIGS. 3 and 4 illustrate an example of the temperature gradient on the mattress.

To maintain the comfort soft of the mattress top and reduce the heat transfer resistant causing by the thick foam layer, the upper layer material of the mattress in the heating pad 2 area and the rest of the area could be constructed differently. The upper layer material in the heating pad area can be a fabric, a foam with small hole pattern, a net or any of these combination.

Consider using such design as described herein in the full, queen and king size mattress, the heating pad 2 can have one or more than one separated heat zone. FIG. 1 illustrates an exemplary embodiment of the heating pad 2 with two separated heating zones 2a and 2b (in dotted line). The electronic controller 3 can be programmed to control each heating zone independently.

One of the most important objectives of the invention is the product safety. Prior arts with heating pads on nearly the entire mattress top surface have raised concerns in safety and health. Users usually sleep on the mattress for a continuous period of 7 to 8 hours. Human body, when in close contact with the heating pad for a long period of time, will significantly increase the chance of having heat burn, electric shock, and side effects arising from closely exposure to electromagnetic fields. Such health risks are especially acute for infants, the elderly, or anyone who might have difficulty feeling hot temperatures or moving if the heating pad does get too hot. Our invention overcomes these concerns by fastening the heating pad 2 on the lower top surface of the mattress body 1, which avoids the user's upper body in close contact with the heating pad yet still keep the entire body comfortably warm.

Another objective of the invention is to reduce cost and energy consumption. Instead of having the heating pad covers the entire mattress top, our design uses much smaller heating pad 2 fastened only on the lower top surface of the mattress body 1. It significantly reduces more than 60% of the material cost and power consumption.

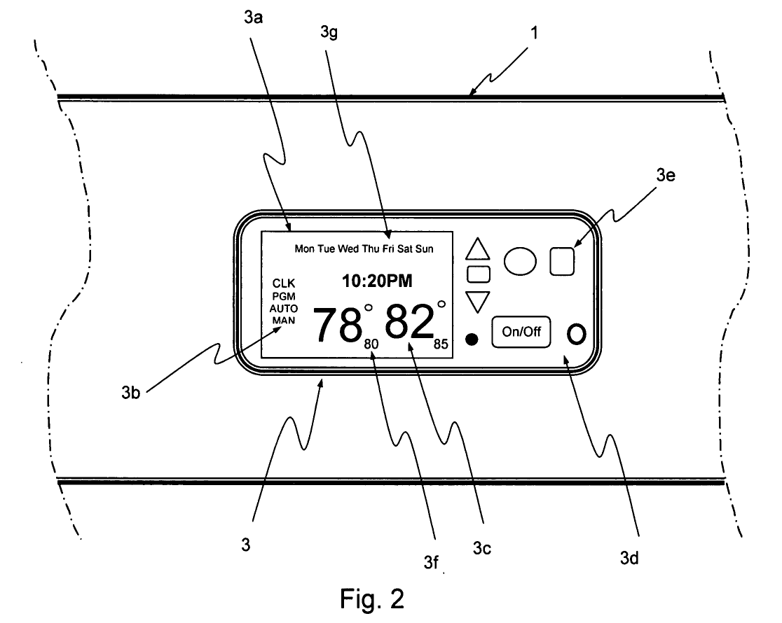

One of the primary features of the invention is to have a programmable microprocessor-based electronic controller 3 automatically controlling and monitoring the heating pad 2 on/off time and temperature. FIG. 2 shows an exemplary embodiment of the controller 3, which is mounted to the mattress body 1. For repair and maintenance purpose, the controller 3 can be easily disconnected and removed from the mattress body 1.

The electronic controller 3 comprises a microprocessor-based hardware, software, and other peripheral components such as a display 3a, a control panel 3d, power cord 5, power supply 6, and plug 7. Plug 7 is a standard wall outlet plug. Power supply 6 converts the wall outlet voltage to low voltage such as 12V, 24V, 36V or other standard low voltage to drive the heating pad. The LCD 3a displays function mode 3b, heating pad temperature 3c, program target temperature 3f, and day and time 3g. By pressing the “Mode” key 3e on the control panel 3d, users can select different function mode: Clock, Program, Auto, and Manual. On “Clock” mode, user can set the controller internal day and time. On “Program” mode, user can set his or her own preferable heating profile. On “Auto” mode, the heating system will run automatically according to the program. On “Manual” mode however, user can manually adjust the heating pad 2 temperature and turn on/off at anytime.

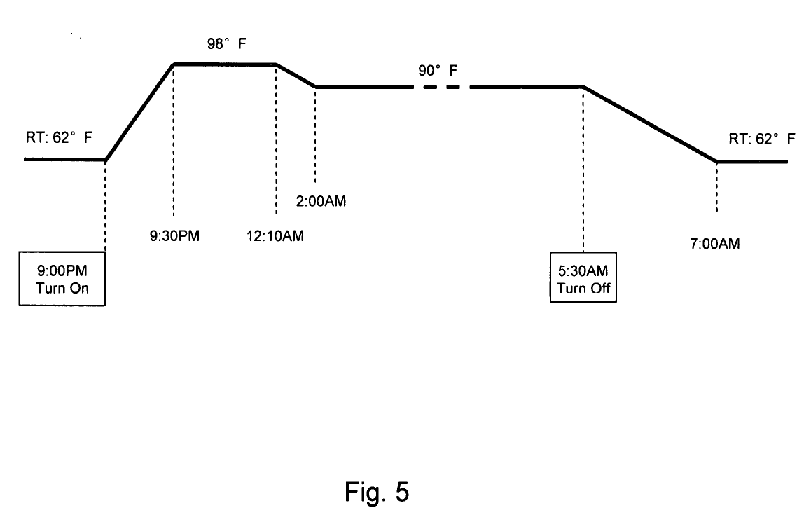

FIG. 5 illustrates an example of program controlled heating profile. The controller 3 can be flexibly programmed for different profile for different individual. On the “Auto” mode the controller 3 automatically turns on the heating pad 2 at 9:00 pm, about half hour before bedtime. It prewarms the heating pad 2 to 98° F. and maintains the same temperature to 12:10 am. From 12:10 am to 2:00 am the controller gradually decreases the heating pad temperature to 90° F. and maintains the same temperature until 5:30 am. At 5:30 am the controller 3 turns off the heating pad 2. The mattress 1 then naturally returns to room temperature.

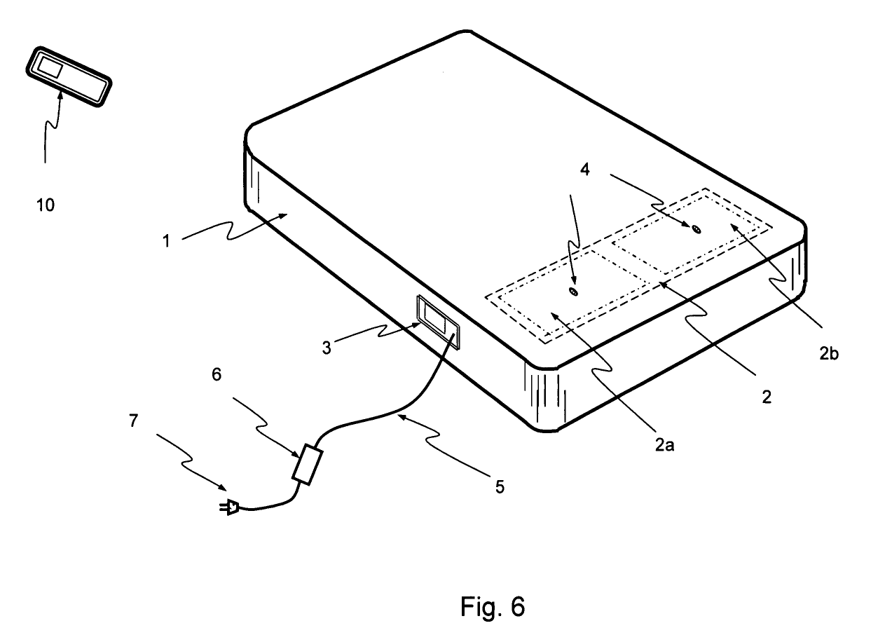

To insure safety, the electronic controller 3 constantly monitors the heating pad 2 temperature during the system running using thermistors 4, which embedded in heating zone 2a and 2b of the heating pad 2, see FIG. 1 and FIG. 6. The controller 3 will turn off the heating pad and generates warning signal both sound and blinking light on display 3a when heating pad 2 temperature exceeds the safety limit.

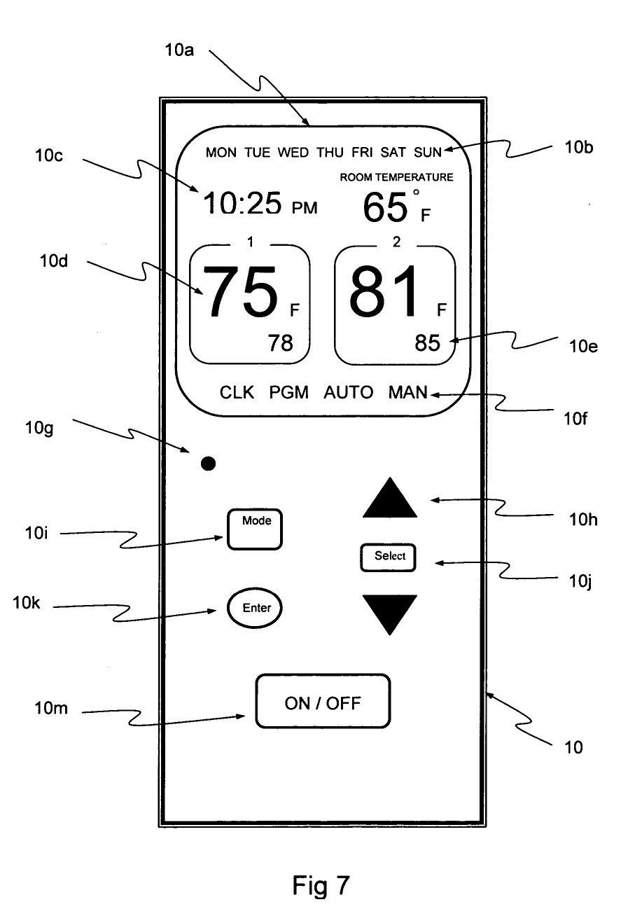

To further providing convenience of operating the electric heating mattress as described herein, the second embodiment of the invention, based upon the first embodiment, provides an additional wireless remote control feature. FIG. 6 illustrates an exemplary design. The programmable microprocessor-based electronic controller is consisted of two separate but similar function units: a base unit 9 and a wireless remote control 10. Similar to the first embodiment, the base unit 9 is mounted to the side of the mattress body 1. Both wireless remote control and the base unit have signal transmission and reception features. There is constant communication between the base unit 9 and the wireless remote control 10 when the system is activated. The wireless remote control 10 can be a tabletop or a handheld unit. User can use either the remote control 10 or the base unit 9 to program and control the heating pad 2, and display information. FIG. 7 illustrates an exemplary design of the remote control. Display 10a displays information such as day 10b and time 10c, heating pad temperature 10d, program target temperature 10e, and function mode 10f. Box 1 and box 2 display heat zone 2a and 2b temperature separately. By pressing the “Mode” key 10i on the keypad, user can select different function mode: Clock, Program, Auto, and Manual. The “Up” and “Down” adjustment keys 10h, “Select” key 10j and the “Enter” key 10k provide the features of adjusting and entering the program values. The “On/Off” key 10m turns on and off the system. Reset key 10g resets the controller to the factory-preset program.

What is claimed is:

1. The programmable thermally controlled electric heating mattress, comprising a mattress and an electric heating pad fastened onto the top surface or under the upper layer material of the mattress. The location of the heating pad is at user's feet position when the user lies down on the mattress. Heat naturally transfers from user's feet to user's upper body, forming a thermal gradient on the mattress.

2. The programmable thermally controlled electric heating mattress according to claim 1, said heating pad has one or more than one heating zone. There is one or more than one thermistor embedded in each heating zone of the heating pad to monitor the heating pad temperature.

3. The programmable thermally controlled electric heating mattress according to claim 1, to reduce the heat transfer resistant causing by the thick foam layer on the mattress top, the upper layer materials of said mattress in the heating pad area and other area of the mattress are constructed differently. The upper layer material in the heating pad area can be a fabric, a foam with hole pattern, a net or any of these combination.

4. The programmable thermally controlled electric heating mattress according to claim 1, said heating pad should easily be disconnected and removed from the mattress body for repair and maintenance.

5. The programmable thermally controlled electric heating mattress according to claim 1, said heating pad is fastened onto said mattress body using Velcro®, buttons, zippers, pockets or similar fastening manner.

6. The programmable thermally controlled electric heating mattress according to claim 1, said heating pad uses standard low voltage such as 36V, 24V, 12V, 5V or other standard low voltage.

7. The programmable thermally controlled electric heating mattress according to claim 1, said heating pad uses standard wall outlet voltage.

8. The programmable thermally controlled electric heating mattress according to claim 1, said heating pad uses DC or AC electric power.

9. The programmable thermally controlled electric heating mattress, further comprising a programmable microprocessor-based electronic controller that controls said electric heating mattress temperature and on/off time. The electronic controller is consisted of microprocessor-based electronic hardware, control software, and other peripheral component such as thermistors, a control panel, a display, a power supply, cables, and plugs.

10. The programmable microprocessor-based electronic controller according to claim 9, user can program different heating profiles as required. On “Auto” mode, the controller as describe herein automatically turn on the heating pad before bedtime, prewarm the mattress to a required temperature, and then turns off at a preset time. The same program can be operated routinely everyday or different program for different day. On “Manual” mode, user can manually adjust the heating pad temperature and turn on/off the system anytime.

11. The programmable microprocessor-based electronic controller according to claim 9, the first design is directly mounted to the mattress body.

12. The programmable microprocessor-based electronic controller according to claim 9, the second design is a separate device that connects to the mattress body using a cable.

13. The programmable microprocessor-based electronic controller according to claim 9, the third design comprises two units: a wireless remote control and a base unit. The base unit is mounted to the mattress body. The wireless remote controller can be a tabletop or handheld device. User should be able to use either the remote control or the base unit to program and control the system.

14. The programmable thermally controlled electric heating mattress according to claim 9, 11, 12 and 13, said controller automatically and manually controls one or more than one separate heating zone of the heating pad independently.

15. The programmable thermally controlled electric heating mattress according to claim 9, 11, 12 and 13, said controller will shut off the heating pad and generates warning signal both sound and blinking light on the display when the heating pad temperature exceeds the safety limit.

16. The programmable thermally controlled electric heating mattress according to claims 9, 11, 12, and 13, said mounted controller and base unit should be easily disconnected and removed from the mattress body for repair and maintenance.
